(19) United States
(12) Patent Application Publication
(10) Pub. No.: US 2004/0252482 A1
(43) Pub. Date: Dec. 16, 2004

(54) Light source device with LEDs

(76) Inventor: Kun-Jung Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/867,851

(22) Filed: Jun. 14, 2004

(30) Foreign Application Priority Data
Jun. 13, 2003 (TW) 92210863

(51) Int. Cl. F21V 7/04

(52) U.S. Cl. 362/31

(57) ABSTRACT

The present invention provides a light source device (3) with point light source for eliminating some dark regions on a light guide plate (31), which has preferably optical uniformity. The light source device includes an LED (32) for providing illumination and the light guide plate. The light guide plate has a first side surface (311) for holding the LED, a second side surface (312) adjacent to the first side surface posited a V-shaped array (3121), an emitting surface (314) joining the first side surface and the second side and a bottom surface (315) opposing to the emitting surface. The first side surface is oblique to the second side surface with an acute angle, and has a light entrance (316) disposed adjacent to the second side surface for receiving light beams emitted by the LED.

### BACKGROUND OF THE INVENTION

1. Field of the Invention

The present invention generally relates to a surface light source device for illuminating a liquid crystal display, more particularly relates to a surface light source device with a light-emitting diode (LED).

2. Description of Prior Art

Display devices represented by liquid crystal display are low-profile, lightweight, and low-power consumption device. Owing to these characteristics, liquid crystal display has recently been used in a field of communication and consumer products, such as personal computer, liquid crystal TV, image telephone and PDA, etc. The liquid crystal display is a passive display, which is capable of forming images of characters or patterns applying a light source device, especially a surface light source device capable providing uniform and high light intensity of illumination.

A conventional surface light source device includes a light guide plate for guiding light and helping the surface light source to get homogeneous light distribution, a light source located adjacent to one or two sides of the light guide plate to illuminate the light guide plate, a reflector arranged under the light guide plate reflecting light to the light guide plate, a diffuser uniforming light and at least a prism enhancing intensity of illumination. In general, light intensity distribution of the light guide plate is decreasing with increasing distance away from the light source, so a plurality of V-shaped grooves or white dots is generally formed on the emitting surface or a bottom surface of the light guide plate, whose density progressively increasing with increasing distance away from the light source so as to attain greater homogeneity of illumination.

Referring to FIG. 4, a conventional light source device 10 includes a light guide plate 120 and a liner light source 110 arranged adjacent to one side of the light guide plate 120. Because an illuminative distribution of the liner light source 110 is not so even, characterized that illumination at two ends of the liner light source 110 is lower than center thereof, illumination at two comers of the light guide plate 10 adjacent to the liner light source 110 is low and relative dart areas 130 form. This affects intensity distribution and homogenous distribution of the light emitting from the light guide plate 120.

Referring to FIG. 5, another conventional light source device 20 includes a light guide plate 220, three LEDs 210 arranged adjacent to one side of the light guide plate 220 and a reflector located under a bottom surface of the light guide plate 220. The LEDs 210 emit light to the light guide plate 210 in a predetermined angle of about 130 degree, so a plurality of triangular dark regions 230 consequently occur on the light guide plate due to little light beams reach these dark areas.

To solve the problem mentioned above, it can add more LEDs to the light source device 20 to reduce a distance between LEDs, so as to satisfy the purposes for attenuating the dark regions 230, but this will increase costs of the light source device 20.

Another solution attenuating the dark regions 230 is that increasing a distance between the light guide plate 220 and the LEDs 210, but this will expand a size of the light source device 20.

### SUMMARY OF THE INVENTION

Accordingly, an object of the present invention is to provide a light source device having high illuminative uniformity.

In order to achieve the objects set out above, a light source device in accordance with the present invention comprises an LED for providing illumination and a light guide plate. The light guide plate has a first side surface for holding the LED, a second side surface adjacent to the first side surface posited a V-shaped array, an emitting surface joining the first side surface and the second side and a bottom surface opposing to the emitting surface. The first side surface is oblique to the second side surface with an angle, and has a light entrance disposed adjacent to the second side surface for receiving light beams emitted by the LED.

These and other features, aspects and advantages of the present invention will become more apparent from the following detailed description and claims, and from the accompanying drawings, in which:

### BRIEF DESCRIPTION OF THE DRAWINGS

FIG. 1 is a schematic perspective view of a preferred embodiment of a light source device in accordance with the present invention;

FIG. 2 is bottom view of a light guide plate of FIG. 1;

FIG. 3 is a schematic elevation view of a second embodiment of a light source device in accordance with the present invention;

FIG. 4 is schematic elevation view of a first conventional light source device, showing an illuminative intensity distribution of a light-emitting surface of a light guide plate; and

FIG. 5 is schematic elevation view of a second conventional light source device, showing an illuminative intensity distribution of a light-emitting surface of a light guide plate.

### DESCRIPTION OF THE PREFERRED EMBODIMENTS

Reference now will be made to the drawings to describe the present invention in detail.

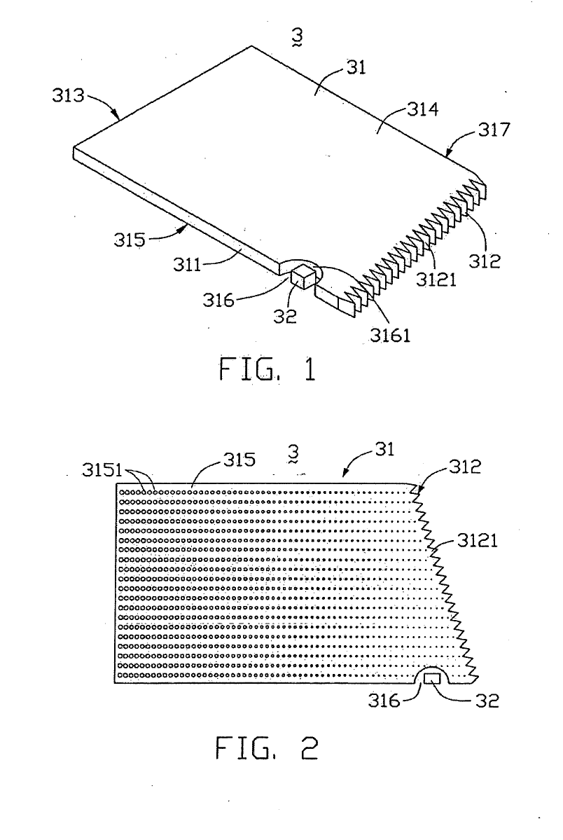

Referring to FIGS. 1 and 2, a preferred embodiment of light source device 3 comprises a light guide plate 31 and an LED 32 for illuminating the light guide plate 31. The light guide plate 31 is substantially a rectangular, transparent plate having a light-emitting surface 314 and an opposite bottom surface 315. A first side surface 311, a second side surface 312 and a third side surface 313 and a forth side surface 317 joint to each other, disposing between the light-emitting surface 314 and the bottom surface 315.

A plurality of scatting dots 3151 distributes on the bottom surface 315, each scatting dots having a form of micro prism, circle, cylinder or square. Area of each scatting dot 3151 increases with increasing distance away from the second surface 312.

The first side surface 311 is oblique to the second side surface 312 with an angle, preferably an acute angle. A light entrance 316 is formed on the first side surface 311 adjacent to the outermost end of the second side surface 312, for receiving light beams emitted by the LED 32. The light entrance 316 is concave and accommodates the LED 32. In other alternative embodiments, a curve surface 3161 of the light entrance 316 has a form of being a partly cylinder surface or partly elliptic surface. Light beams emitted from the LED 32 can incident perpendicularly to the curve surface 3161, which can reduce light power lost occurred by reflection on the curve surface 3161. To further improve the light power utility, a radian of the light entrance 316 is equal to the emitting angle of the LED 32, so that the light beams emitted from the LED 32 can wholly enter the light guide plate 31. More preferably, adjusting a frontage of the LED 32 to illuminate entire the second surface 312 of the light guide plate 31, so as to attain a more uniform illumination of the light guide plate 31.

A V-shaped array 3121 is form on the second surface 312 for reflecting light beams emitted by the LED 32 in a direction being parallel to the first surface 311, functioning as a linear source. A height of the V-shaped array 3121 increases with increasing distance away from the LED 32, enhancing light intensity away from the LED 32, so as to compensate a far end of the second surface 312 away from the LED 32. In an alternative embodiment, an angle of the V-shaped array 3121 increases with increasing distance away from the LED 32, having the same function of uniforming the illuminative distribution of the light guide plate 31.

In addition, a plurality of V-shaped grooves are formed on the light-emitting surface 314; the light source device 3 further includes a reflector (not shown) placed under the bottom surface 315 of the light guide plate 31, and a reflector (not shown) bonded on the second side surface 312.

Because the V-shaped array 3121 combining the LED 32 functions as a virtual linear source, the problem of dark regions formed near the light incident surface in prior art is eliminated, and a plurality of LEDs are saved. Therefore costs and power consumption of the light source device 3 are both cut down. At the same time, light beams emitted by LED 32 can be reflected and diffused by the second surface 312 of the light guide plated 31 to evenly illuminate the light guide plate 31, therefore a uniform illuminative distribution can be attain of the light source device 3.

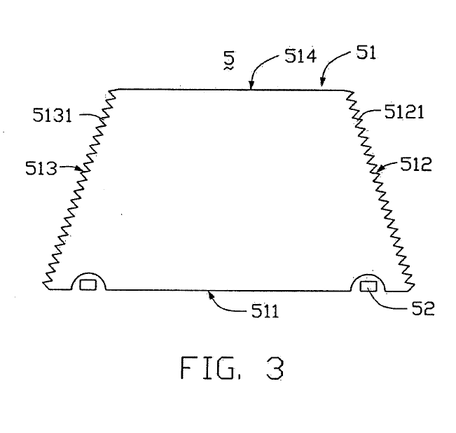

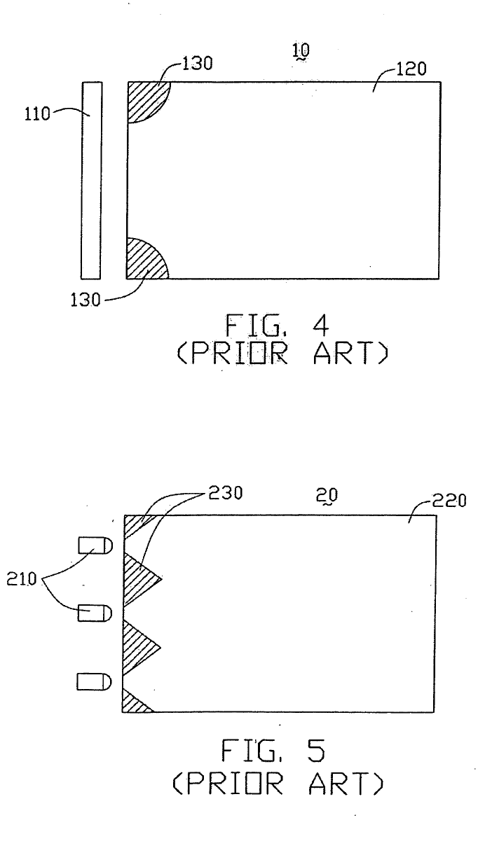

Further, a light source device of another embodiment in accordance with the present invention is provided too. Referring to FIG. 3, the light source device 5 substantially has a monosymmetrical structure, which has two parallel side surface 511, 514 and two symmetrical oblique side surface 513, 512, and two LEDs 52. Two V-shaped arrays 5131, 5121 are formed on the two side surface 513, 512 respectively being similar to the V-shaped array 3121 disclosed in the preferred embodiment. In an alternative embodiment, the light source device 5 substantially may has an acentrosymmetric structure, which the two side surface 513, 512 are substantially parallel and the two LEDs are placed adjacent to the two side surface 511, 514 respectively.

While the present invention has been described with reference to particular embodiments, the description is illustrative of the invention and is not to be construed as limiting the invention. Therefore, various modifications of the described embodiments can be made by those skilled in the art without departing from the true spirit and scope of the invention as defined by the appended claims.

1. A light source device comprising:
an LED for providing illumination;
a light guide plate having:
a first side surface for holding the LED;
a second side surface adjacent to the first side surface posited a V-shaped array;
an emitting surface joining the first side surface and the second side; and
a bottom surface opposing to the emitting surface;
wherein the first side surface is oblique to the second side surface with an angle, having a light entrance disposed adjacent to the second side surface for receiving light beams emitted by the LED.

2. The light source device as recited in claim 1, wherein the light entrance is concave and accommodates the LED.

3. The light source device as recited in claim 2, wherein a curve surface of the light entrance is a partly cylinder surface or partly elliptic surface opposite to LED.

4. The light source device as recited in claim 2, wherein a radian of the light entrance is equal to an emitting angle of the LED.

5. The light source device as recited in claim 1, wherein a height of the V-shaped array increases with increasing distance away from the LED.

6. The light source device as recited in claim 1, wherein a width of the V-shaped array increases with increasing distance away from the LED.

7. The light source device as recited in claim 1, wherein an angle of the V-shaped array increases with increasing distance away from the LED.

8. The light source device as recited in claim 2, wherein a plurality of scatting dots posited on the bottom surface.

9. The light source device as recited in claim 8, wherein each scatting dots is a micro prism, circle, cylinder, square or pyramid structure.

10. The light source device as recited in claim 2, wherein the emitting surface has V-shaped grooves.

11. The light source device as recited in claim 1, wherein further comprising a reflector placed under the bottom surface of the light guide plate.

12. The light source device as recited in claim 1, wherein further comprising a reflector bonded on the second side surface.

13. The light source device as recited in claim 1, wherein the angle is an acute angle.

14. A light source device comprising:
a light guide plate defining four sides including two spaced parallel long sides and at least one slanted short side joined therebetween under a condition that a first end of said slanted short side is essentially located at an outer position and a second end of said slanted short side, opposite to said first end, is essentially located at an inner position along a lengthwise direction defined by said long sides;
at least one light-emitting diode (LED) disposed on one of said long sides which is joined with said slanted short side at the first end of the slanted short side, and said LED positioned close to said first end; wherein
said slanted short side is serrate.

15. The light source device as recited in claim 14, wherein said light guide plate further includes another slanted short side symmetrically arranged with said slanted short side, another LED is disposed on the same long side and close to an end of said another slanted short side which is close to an outer position along said lengthwise direction, and said slanted short side is serrate.

16. The light source device as recited in claim 14, wherein said light guide plate defines a bottom face perpendicular to all said long sides and said short sides, and a plurality of scatting dots are formed on the bottom face under a condition that the scatting dots close to said LED are smaller than those which are farther away from the LED.

17. The light source device as recited in claim 14, wherein a position of said LED along said lengthwise direction is essentially similar to that of the second end of said slanted short side along said lengthwise direction.
